(19) United States
(12) Patent Application Publication
(10) Pub. No.: US 2011/0194183 A1
(43) Pub. Date: Aug. 11, 2011

(54) Apparatus For Enhancing Scattered Light Detection By Re-Directing Scattered Light Outside The Angular Range Of Collection Optics Back To The Sample And Method Of Fabricating Same

(75) Inventors: Jan Lipson, Cupertino, CA (US); Janyce Lipson, Cupertino, CA (US); Rudolf J. Hofmeister, San Jose, CA (US); Donald A. Ice, Milpitas, CA (US); Sascha Hallstein, Los Gatos, CA (US)

(73) Assignee: C8 MEDISENSORS INC., Los Gatos, CA (US)

(21) Appl. No.: 13/021,004

(22) Filed: Feb. 4, 2011

Related U.S. Application Data
(60) Provisional application No. 61/302,008, filed on Feb. 5, 2010.

(51) Int. Cl. G02B 17/08; G02B 5/08; G02B 1/11; G02B 5/10; B24B 1/00

(52) U.S. Cl. 359/601; 359/850; 359/838; 359/727; 451/42

(57) ABSTRACT

An apparatus comprising an optical window transmits both an excitation beam to a sample and scattered light from the sample which is within the angular range of the collection optics. Scattered light from the sample outside the angular range of the collection optics is re-directed back to the sample by reflection from one or more surfaces of the apparatus. As a result, the magnitude of scattered light collected is increased.

### CROSS-REFERENCE TO RELATED APPLICATIONS

This application claims the benefit of U.S. Provisional Application No. 61/302,008, filed Feb. 5, 2010, the content of which is incorporated by reference herein in its entirety.

### BACKGROUND OF THE INVENTION

1. The Field of the Invention

This invention relates to an optical window in the proximity of a sample wherein an excitation beam is passed by the window to the sample and where scattered light from the sample within a range of desired collection angles is passed by the window, and wherein scattered light at angles outside the collection angles is redirected back to the sample. Some portion of the light which is re-directed back to the sample may be scattered into the range of collection angles hence enhancing the signal.

2. Background and Relevant Art

When an object is illuminated with a beam of optical radiation for the purpose of gathering scattered light from the object, there are in general practical limits on the size of the solid angle in which the scattered light can be collected. Light outside the range of collection angles is in general lost and does not contribute to the signal. In instances where efficient signal detection is critical, the loss of potentially useful light is disadvantageous.

The light which is lost is comprised of radiation which is elastically scattered from the sample but may contain in-elastically scattered light such as from fluorescence or Raman scattering. If it is desired to observe the in-elastically scattered light, it is usually necessary to have some means of rejecting the elastically scattered radiation. Because some of the elastically scattered radiation emerges outside the range of the collection angles, it will be incident on surfaces in the apparatus outside the clear aperture of the optical collection elements. It can be difficult to reject such radiation with adequate efficiency.

When observing in-elastically scattered light it can be seen that the emergence of elastically scattered light from the sample is a source of inefficiency for if the elastically scattered light was confined to the sample it can generate additional in-elastic scattering. Further, if the in-elastically scattered light which was not in the range of collection angles was confined to the sample, there is finite probability that it will be scattered into the range of the collection angles. Hence, there are two disadvantageous loss mechanisms when observing the in-elastically scattered light.

It also can be highly advantageous to have an optical window in close proximity to a sample when performing scattering measurements. The window can help stabilize the sample, thermally, mechanically, and optically which can be important when performing measurements that are sensitive to variations in any of these properties. Such windows, in general, admit an excitation beam and pass scattered light within the range of the collection angles but have no means of recovering any light which is scattered outside the collection angles.

### BRIEF SUMMARY OF THE INVENTION

These and other limitations are addressed by the present invention, which discloses an apparatus whereby scattered light from a sample, emitted outside the angular range of the collection optics, can be re-directed back to the sample.

In one embodiment, an optical window is employed wherein radiation from an excitation source is passed to the sample, and wherein scattered radiation from the sample within a range of collection angles is also transmitted. Some or all of the radiation outside the range of collection angles is reflected from a substantially planar second surface of the window which is the surface more distant from the sample than the first surface which is in proximity to the sample. Some or all of the light reflected from this second surface is then reflected a second time by yet a third surface, in substantially a direction opposite to that at which the light is incident on this third surface. The light reflected by the third surface then is reflected yet again by the second surface, returning substantially to the sample. Some portion of the light returned to a sample when scattered back from the sample will be scattered into the range of the collection angles. Light at the excitation wavelength which is returned to the sample, may, in addition, generate additional in-elastically scattered light.

In a preferred embodiment the third surface, from which light is reflected a second time, is substantially spherical. In yet another embodiment, the surface which is in proximity to the sample is substantially planar. In yet a third embodiment some of the light which is reflected from the planar surface is reflected via the mechanism of total internal reflection. In another preferred embodiment, the surface which reflects the light for the second time is coated so as to be highly reflective to the radiation which is incident upon it. In addition, the planar surface which is remote from the sample can be anti-reflection coated. A method of creating the desired geometry from a section of a spherically shaped transparent material is also presented.

### BRIEF DESCRIPTION OF THE DRAWINGS

FIG. 1A is an isometric drawing of an optical window having surfaces that perform the functions of the invention.

FIG. 1B is a cross-sectional view of the optical window and the sample showing the excitation beam, the collected scattered beam, and the re-directed scattered light which is outside the range of the collection angles.

FIG. 2 is an alternate embodiment where a curved surface of the window has an apex in proximity to the emission.

FIG. 3 is another alternate embodiment in which the emission point is in the proximity of the center of curvature of a reflecting surface.

### DETAILED DESCRIPTION OF THE PREFERRED EMBODIMENTS

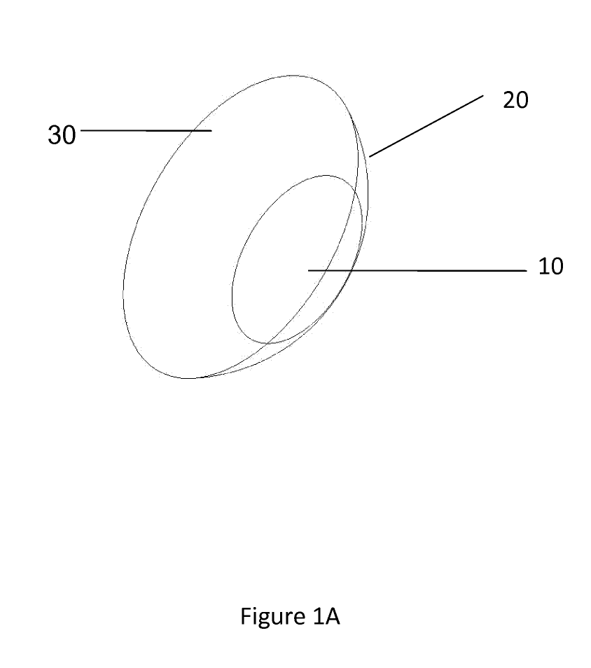

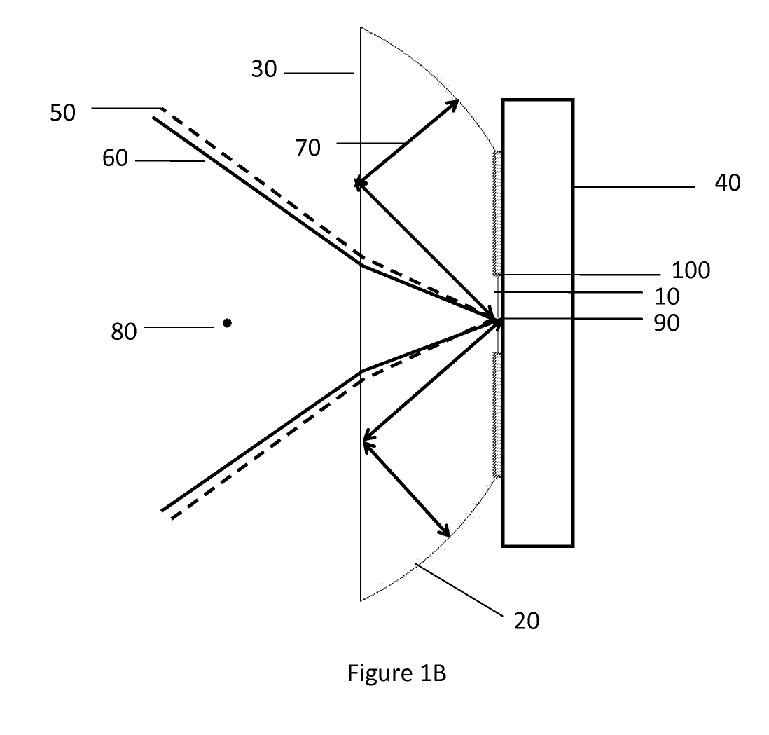

Referring to FIG. 1A, an isometric drawing of an optical window which has a form suitable for this invention is presented. Surface 10 is in proximity to a sample whereas surface 20 is a reflector.

A cross-section of the apparatus is presented in FIG. 1B. The sample 40 is in close proximity to surface 10. The excitation beam 60 is substantially transmitted by surface 30 and by surface 10. The scattered radiation 50 from the emission point 90 within the angular range of the collection optics is also substantially transmitted by surface 30 and surface 10. Scattered radiation 70 which is outside the angular range of the collection optics is reflected by surface 30, reflected a second time by surface 20, and a third time by surface 30 returning substantially to emission point 90.

In a preferred embodiment, surface 20 is spherical and centered on point 80. Point 80 is located at a distance from surface 30 substantially equal to the distance of the point of emission on the sample 90 from surface 30. In such an arrangement, a ray originating from point 90 and reflected by surface 30 will, after reflection by surface 20 and a second reflection from surface 30 return to point 90.

In a particularly preferred embodiment the diameter of surface 10 corresponds to the desired aperture diameter of the system, which is the area from which light is desired to be collected. Surface 20 is coated with a highly reflective material. Hence, the aperture defined by surface 10 is surrounded by material opaque to the incident radiation and is therefore well defined. If it is not convenient that the entirety of surface 10 constitute the aperture, it is possible to define an additional aperture, indicated by item 100.

In order for the invention described to provide enhanced signal, sample 40 must have nonzero scattering, which scattering can be of a surface or volumetric nature. If the sample produces a purely specular reflection the excitation beam will return upon itself, and no rays such as item 70 are generated. If sample 40 has substantial elastic scattering then rays such as item 70 will be generated by the excitation beam, and a proportion of such rays will be returned by the apparatus to the sample. If the sample has inelastic scattering properties, some rays resulting from such in-elastic scattering, such as 70, which are outside the angular range of the collection optics will be returned to the sample. Such returning rays have finite probability of being scattered into the angular range of the collection optics, thus enhancing the signal of the inelastic scattering. In addition, rays such as 70 of the scattered excitation beam upon returning to the sample will produce additional inelastic scattered radiation, thus additionally enhancing the signal associated with the inelastic radiation. These enhancements can be substantial, as typically, even very fast collection optics only collect less than 10% of isotropically emitted light from a surface. By returning a large fraction of the total light emitted from the surface back to the sample a useful increase in the signal size is possible. That enhancement may be particularly important with weak processes such as Raman scattering where it can be difficult to collect sufficient signal in an acceptable integration time.

An anti-reflection coating is advantageously applied to surface 30 in FIG. 1B, in the region where the excitation beam and scattered radiation within the angular range of the collection optics are expected to pass. If the index of refraction of the material of the optical window of FIG. 1A is greater than that of the medium in contact with surface 30, total internal reflection will occur in some range of angles. In another preferred embodiment the index of refraction of the material of the window is chosen to be sufficiently high that a sufficient proportion of the light outside the angular range of the collection optics is totally internally reflected at surface 30. As an example if the window is chosen to be made of sapphire, and surface 30 is in contact with air, rays of angle of incidence greater than approximately 35° will undergo total internal reflection. If the scattering at the sample is isotropic, approximately 82% of the scattered radiation will undergo total internal reflection. If the proportion undergoing total internal reflection is sufficient, it is possible to avoid applying a reflecting coating to those regions of surface 30 where reflection is desired. Other high index materials which are suitable in this preferred embodiment include zirconia, single crystal silicon carbide, and diamond. For radiation beyond about 1 um single crystal silicon is an advantageous choice. Other semiconductor materials of high index are suitable at other wavelengths where they are highly transmissive. Alternatively, a high reflection coating can be applied to the area of surface 30 where transmission of light is not required.

In another preferred embodiment, the interface between surface 10 and the sample is substantially index matched such that an anti-reflection coating is unnecessary to substantially transmit the excitation beam 60 and the scattered radiation 50 and 70. It will be noted that a good anti-reflection coating would be difficult to realize for both rays 50 and 70 because of large differences in the angle of incidence on surface 10. A suitable index matching fluid such as water or an appropriate oil may be employed between surface 10 and the sample.

In another preferred embodiment, the aperture 100 of FIG. 1B is fabricated from a reflecting material. If the sample has volume scattering characteristics and is not opaque, light emerging from the sample outside the clear area of the aperture will be re-directed back to the sample. Such redirected light can result in signal enhancement as described in the foregoing.

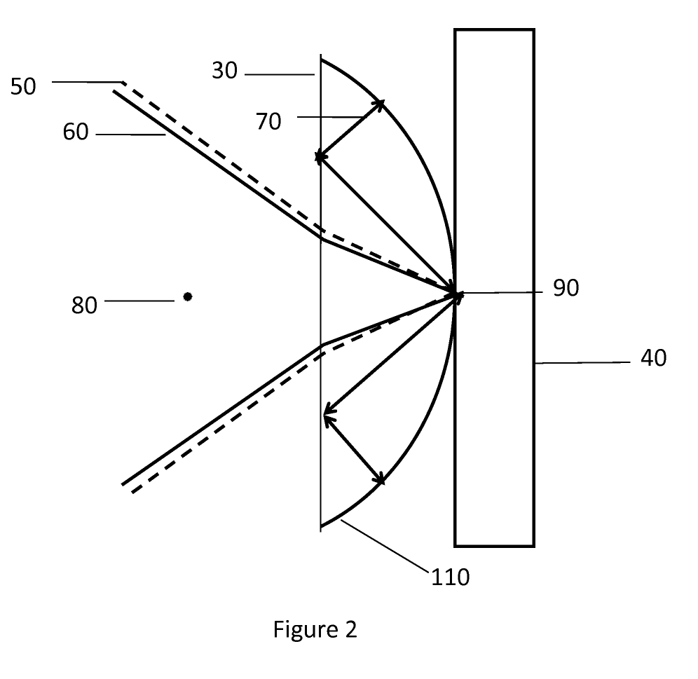

It is not always necessary that surface 10 of FIG. 1B be strictly planar. An alternative arrangement is presented in FIG. 2 where the curved surface 110 is continued to an apex in the vicinity of emission point 90. Such an arrangement may be advantageous when the image aperture is very small and hence the area being imaged would still be substantially planar. The arrangement also may be advantageous if the optical system inherently has curvature of field. If the sample 40 is deformed to the same curvature of surface 110 such that it is substantially in contact with surface 110, and if the resulting curvature compensates all or part of the curvature of field of the collection optics then an image with smaller aberrations may be obtained.

It is also not necessary in all circumstances that surface 30 of FIG. 1B be strictly planar or that surface 20 be strictly spherical. Alternatives would include aspheric surfaces including conic sections of revolution, or of polynomial form. Deviations of surface 30 from planarity or surface 20 from spherical form will cause some rays 70 emitted from point 90 not to return exactly to point 90 but it is sometimes satisfactory to have them return to the sample anywhere within the collection aperture.

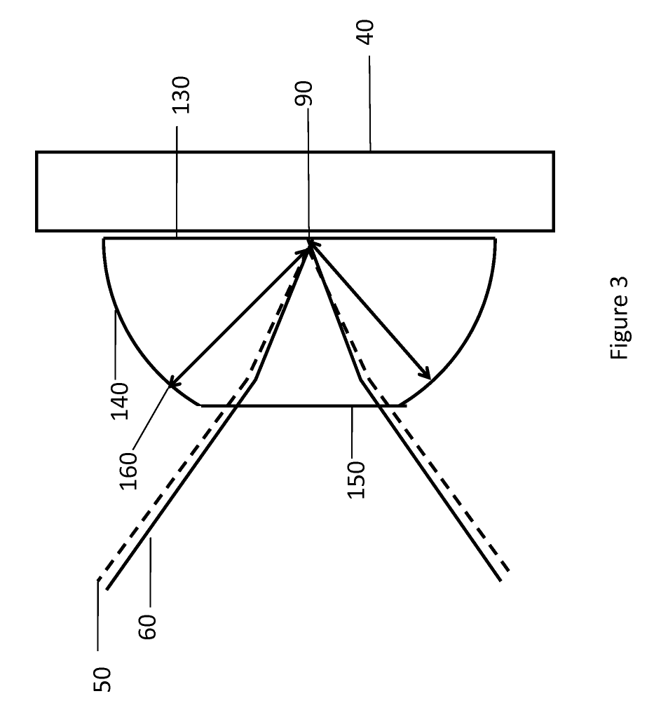

Another embodiment which also has the property of re-directing some of the light which is scattered outside the angular range of the collection optics back to the sample is presented in FIG. 3. Here, the center of curvature of surface 140 is in the proximity of emission point 90. Rays 160 emitted from point 90 and reflected by surface 140 are redirected back to the sample. Surfaces 130 and 150 are substantially planar. It is advantageous to deposit a high reflectivity coating on surface 140 and an anti-reflection coating on surface 150. It is also advantageous to index match the interface between surface 130 and the sample 40. Surfaces 150 and 90 need not be strictly planar, and surface 140 need not be strictly spherical.

In one embodiment, surface 150 is curved similarly to surface 140, such that together surfaces 140 and 150 form a single continuous curved surface. In one embodiment, the curved surface combining surfaces 140 and 150 comprises anti-reflection coating within the angular range of the collection optics, and/or a high reflectivity coating outside the angular range of the collection optics.

An advantageous method for fabricating the embodiment presented in FIGS. 1A and 1B is to first begin with a sphere having a radius that corresponds to the desired radius of curvature of surface 20. Planar surfaces 30 and 10 can then be formed by grinding and polishing, and coatings can be applied subsequently. In a preferred embodiment, surface 20 is coated for high reflection prior to forming surface 10. The subsequent process of grinding and polishing surface 10 removes the high reflection coating from the area which is intended to serve as the aperture for light transmission. The embodiments presented in FIGS. 2 and 3 can also be fabricated by using a sphere as a starting point.

1. An optical window for re-directing scattered radiation, the optical window comprising:
a first surface in proximity to a sample, the first surface substantially transparent to radiation transmitted to and emitted from an emission point of the sample;
a second surface distal from the sample, the second surface reflecting radiation emitted from the emission point at a first angle with respect to a normal of the first surface, the first angle being outside an angular range of a collection optics; and
a third surface, adjacent to the first and second surfaces, the third surface reflecting the radiation reflected from the second surface at a second angle substantially normal to the third surface, wherein the radiation reflected from the third surface is transmitted to the second surface and is reflected from the second surface substantially back toward the emission point.

2. The optical window of claim 1 wherein the first surface is substantially planar.

3. The optical window of claim 1 wherein the first surface comprises an aperture.

4. The optical window of claim 3 wherein the aperture comprises a reflective material.

5. The optical window of claim 1 wherein the second surface is substantially planar.

6. The optical window of claim 1 wherein the second surface comprises an anti-reflection coating.

7. The optical window of claim 6 wherein the anti-reflection coating covers an area comprising the angular range of the collection optics.

8. The optical window of claim 1 wherein the second surface comprises a reflective coating covering an area outside the angular range of the collection optics.

9. The optical window of claim 1 wherein the third surface is substantially spherical.

10. The optical window of claim 9 wherein the third surface is substantially spherical about a point located along a line normal to the first surface through the emission point, wherein the point is located on an opposite side of the second surface from the sample, and wherein the point is located equidistant from the second surface as the sample is from the second surface.

11. The optical window of claim 1 wherein the third surface comprises a reflective coating.

12. The optical window of claim 1 wherein a first index of refraction of the optical window is greater than a second index of refraction of a medium in contact with the third surface.

13. The optical window of claim 1 wherein the first angle is sufficiently large to cause total internal reflection at the second surface.

14. The optical window of claim 1 wherein a first index of refraction of the optical window is sufficiently high so as to cause total internal reflection at the first angle at the second surface.

15. The optical window of claim 1 wherein a first index of refraction of the optical window substantially matches a third index of refraction of the sample.

16. The optical window of claim 1, wherein the optical window comprises sapphire.

17. The optical window of claim 1 wherein the first and third surfaces are substantially spherical about a point located along a line normal to the first surface through the emission point, wherein the point is located on an opposite side of the second surface from the sample, and wherein the point is located equidistant from the second surface as the sample is from the second surface.

18. The optical window of claim 1 wherein the third surface is substantially spherical about the emission point.

19. The optical window of claim 18 wherein the second surface is substantially planar in the angular range of a collection optics.

20. A method for fabricating an optical window for re-directing scattered radiation, the method comprising:
grinding a first surface of a sphere;
polishing the first surface such that the first surface is substantially transparent to radiation incident to and emitted from an emission point of a sample in proximity to the first surface;
grinding a second surface of the sphere;
polishing the second surface such that the second surface reflects radiation emitted from the emission point at a first angle with respect to a normal of the first surface, the first angle being outside an angular range of a collection optics; and
polishing a third surface of the sphere adjacent to the first and second surfaces such that the third surface reflects the radiation reflected from the second surface at a second angle substantially normal to the third surface, wherein the radiation reflected from the third surface is transmitted to the second surface and is reflected from the second surface substantially back toward the emission point.

21. An optical window for re-directing scattered radiation, the optical window comprising:
a first surface in proximity to a sample, the first surface substantially transparent to radiation transmitted to and emitted from an emission point of the sample; and
a second surface distal from the sample, the second surface reflecting radiation emitted from the emission point at a first angle with respect to a normal of the first surface, the first angle being outside an angular range of a collection optics, the second surface reflecting the radiation at a second angle substantially normal to the second surface, wherein the radiation is reflected substantially back toward the emission point, and wherein the second surface substantially spherical about the emission point.

22. The optical window of claim 21 wherein the second surface comprises an anti-reflection coating covering an area comprising the angular range of the collection optics.

23. The optical window of claim 21 wherein the second surface comprises a reflective coating covering an area outside the angular range of the collection optics.

24. The optical window of claim 21 wherein a first index of refraction of the optical window is greater than a second index of refraction of a medium in contact with the second surface.
